(19) United States
(12) Patent Application Publication
(10) Pub. No.: US 2021/0117807 A1
(43) Pub. Date: Apr. 22, 2021

(54) METHODS AND APPARTUS TO CONSTRUCT PROGRAM-DERIVED SEMANTIC GRAPHS

(71) Applicant: Intel Corporation, Santa Clara, CA (US)

(72) Inventors: Shengtian Zhou, Palo Alto, CA (US); Fangke Ye, Atlanta, GA (US); Roshni G. Iyer, Fremont, CA (US); Jesmin Jahan Tithi, San Jose, CA (US); Justin Gottschlich, Santa Clara, CA (US)

(21) Appl. No.: 17/133,168

(22) Filed: Dec. 23, 2020

(51) Int. Cl. G06N 5/00; G06N 5/02; G06K 9/62; G06F 40/00

(52) U.S. Cl. CPC G06N 5/003; G06F 40/00; G06K 9/6215; G06N 5/027

(57) ABSTRACT

Methods, apparatus, systems and articles of manufacture are disclosed to construct and compare program-derived semantic graphs comprising a leaf node creator to identify a first set of nodes within a parse tree, set a first abstraction level of a program-derived semantic graph (PSG) to contain the first set of nodes, an abstraction level determiner to access a second set of nodes, the second set of nodes to include the set of nodes in the PSG, create a third set of nodes, the third set of nodes to include the set of possible nodes at an abstraction level, determine whether the abstraction level is deterministic, a rule-based abstraction level creator to in response to determining the abstraction level is deterministic, construct the abstraction level, and a PSG comparator to access a first PSG and a second PSG, determine if the first PSG and the second PSG satisfy a similarity threshold.

### FIELD OF THE DISCLOSURE

This disclosure relates generally to code representations and, more particularly, to a methods and apparatus to construct program-derived semantic graphs.

### BACKGROUND

In recent years, a desire to create graphical representations of computer programs has arose. Programmers wish to graphically represent programs to convey the processes and/or methods performed by the program. These representations may allow for Artificial Intelligence systems (e.g., deep learning systems) to perform various coding tasks like automatic software bug detection or code structure suggestions. Some examples of prior graphical representations of programs include decision trees, abstract syntax trees, Kripke structures, and computational tree logic diagrams.

### BRIEF DESCRIPTION OF THE DRAWINGS

FIG. 1 is a schematic illustration of a process to construct program-derived semantic node graphs.

FIG. 2 is a block diagram representing a program-derived graph constructor.

FIG. 3 is a block diagram representing an example implementation of the rule-based abstraction level creator of FIG. 2.

FIG. 4 is a block diagram representing an example implementation of the learning-based abstraction level creator of FIG. 2.

FIG. 5 is a flowchart representative of machine-readable instructions which may be executed to implement the program-derived graph constructor of FIG. 2.

FIG. 6 is a flowchart representative of machine-readable instructions which may be executed to implement the rule-based abstraction level creator of FIG. 3.

FIG. 7 is a flowchart representative of machine-readable instructions which may be executed to implement the learning-based abstraction level creator of FIG. 4.

FIG. 8 is a block diagram of an example processing platform structured to execute the instructions of FIG. 5 to implement the program-derived graph constructor of FIG. 2.

FIG. 9 is a block diagram of an example software distribution platform to distribute software (e.g., software corresponding to the example computer readable instructions of FIGS. 5, 6, and 7) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Machine Programming (MP) is concerned with the automation of software development. In recent years, the emergence of big data facilitates technological advancements in the field of MP. One of the core challenges in MP is code similarity, which aims to tell if two code snippets are semantically similar. An accurate code similarity system can enable various applications ranging from automatic software patching to code recommendation. Such systems can improve programmer productivity by assisting programmers in various programming stages (e.g., development, deployment, debugging, etc.). To build accurate code similarity systems, one core problem is to build an appropriate representation that can accurately capture the semantic fingerprint of a code.

Some common representations include graph representations (e.g., trees, sequence of program tokens, etc.). It has been demonstrated that tree representation of code can effectively capture code semantic information that can aid a learning system for learning code semantics. However, one of the issues of this work is that the representation, named the context-aware semantic structure (CASS), although effective in capturing code semantics, may not provide direct code explanations that can assist programmers in understanding and comparing codes. To provide better explanations for code, this application proposes the concept of program-derived semantic graphs, which is a graph representation of code that consists of different abstraction levels to accurately capture code semantics. Example approaches disclosed herein mix rule-based and learning-based approaches to identify and build the nodes of a program-derived semantic graph at various abstraction levels.

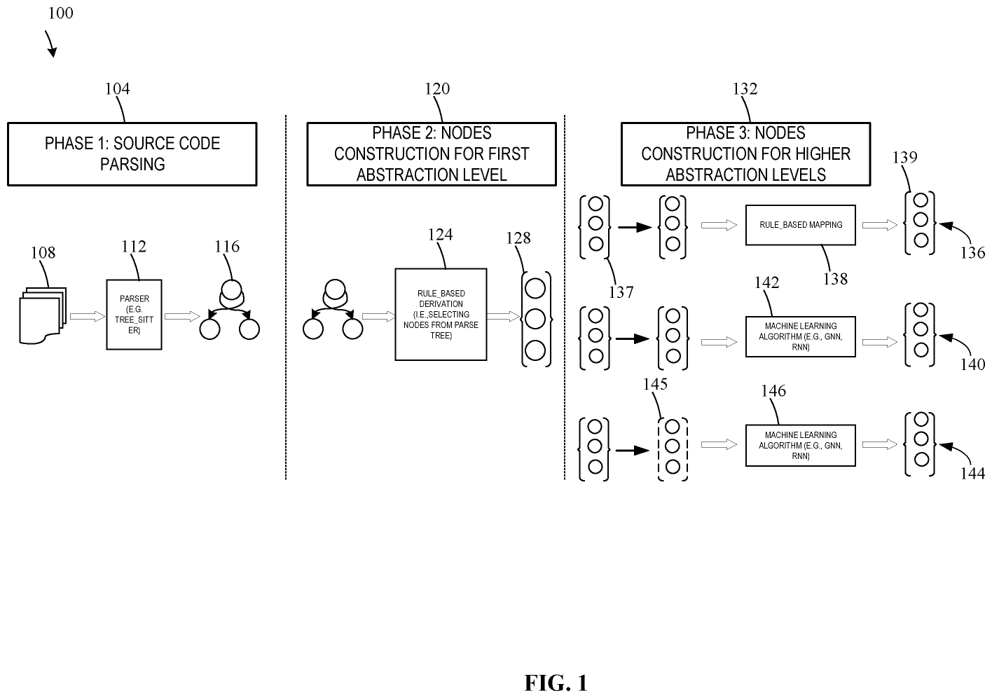

FIG. 1 is a schematic illustration of a process to construct program-derived semantic node graphs. In the following examples, the process to construct program-derived semantic node graphs occurs in three phases. In these examples, the first phase is Phase One: Source Code Parsing 104. In Phase One, the application accesses a code snippet 108 of a computer program, application, etc. The code snippet 108 can be any computer programming language (e.g., Java, C, C++, Python, etc.). An example parser 112 accesses the code snippet 108 and converts the code snippet into a parse tree 116.

The second phase in these examples is Phase Two: Node Construction for First Abstraction Level 120. In these examples, a leaf node creator 124 accesses the syntactical nodes in the parse tree 116. The leaf node creator 124 sets the syntactical nodes in the parse tree 116 as leaf nodes 128 in the program-derived semantic graph.

The third and final phase in these examples is Phase Three: Node Construction for Higher Abstraction Levels 132. In these examples, Phase Three: Node Construction for Higher Abstraction Levels 132 determines one of three options to perform based on whether the current abstraction level is deterministic, and whether attention should be used for the current abstraction level. In these examples, the first option is a Rule-Based Construction for a Deterministic Abstraction Level 136. In the Rule-Based Construction for a Deterministic Abstraction Level 136, the program-derived semantic graph constructor determines that the current abstraction level is deterministic. For an abstraction level to be deterministic, the input nodes 137 to the current abstraction level have a single possible parent node in the set of possible nodes at the current abstraction level. The Rule-Based Mapper 138 accesses the set of input nodes 137 and determines a parent node for each input node from the set of possible nodes at the current abstraction level. The Rule-Based Mapper 138 saves the determined set of nodes at the current abstraction level 139 to the program-derived semantic graph.

The second option in Phase Three: Node Construction for Higher Abstraction Levels 132 is a Learning-Based Construction for Non-Deterministic Abstraction Levels without Attention 140. In the Learning-Based Construction for Non-Deterministic Abstraction Levels without Attention 140, the Learning-Based Mapper 142 accesses the set of input nodes 137 and determines the set of nodes for the current abstraction level 139 to include in the program-derived semantic graph at the current abstraction level. For an abstraction level that is non-deterministic, at least one input node in the set of input nodes 137 has at least two possible parent nodes in the set of possible nodes at the current abstraction level. In these examples, the Learning-Based Mapper 142 uses a probabilistic model to determine one of the at least two possible parent nodes to include in the set of nodes at the current abstraction level 139.

The third option in Phase Three: Node Construction for Higher Abstraction Levels 132 is a Learning-Based Construction for Non-Deterministic Levels with Attention 144. In the Learning-Based Construction for Non-Deterministic Levels with Attention 144, a Learning-Based Mapper 146 accesses a set of input nodes 137. The Learning-Based Mapper 146 determines a subset of input nodes 145 to utilize in determining the set of nodes to include at the current abstraction level 139. The Learning-Based Mapper 146 sets a weight for input nodes in the set of input nodes 137 based on the likelihood that a specified node has a parent in the current abstraction level. The Learning-Based Mapper 146 accesses the subset of input nodes 145 that meet a threshold value based on the weight of the input nodes. The Learning-Based Mapper 146 determines a set of nodes to include in the current abstraction level 139 from a set of possible nodes at the current abstraction level based on the subset of input nodes 145.

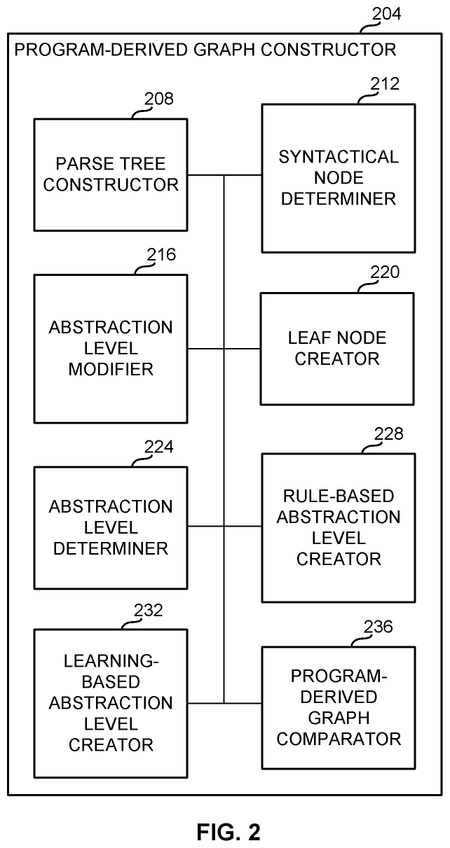

FIG. 2 is a block diagram representing an example program-derived graph constructor 204. The program-derived graph constructor 204 accesses a code snippet from an application or computer program. The application or computer program runs on a computer language (e.g., Java, C, C++, Python, etc.). The program-derived graph constructor 204 creates a program-derived semantic graph based on the code snippet. The program-derived semantic graph is a hierarchical node graph displaying relationships between commands in the code snippet and more abstract command groups. The program-derived graph constructor 204 includes an example parse tree constructor 208, an example syntactical node determiner 212, an example abstraction level modifier 216, an example leaf node creator 220, an example abstraction level determiner 224, an example rule-based abstraction level creator 228, an example learning-based abstraction level creator 232, and a program-derived graph comparator 236.

The example parse tree constructor 208 of the program-derived graph constructor 204 of the illustrated example of FIG. 2 converts a snippet of program code into a parse tree. As used herein, a snippet of program code is defined as a sequence of one or more instructions represented by program code. In some examples, the parse tree includes the words, mathematical operations, and/or formatting present in the segment or snippet of program code. In some examples, the parse tree includes nodes that are syntactical values (e.g., mathematical operations, integers, if-else statements, etc.).

The example syntactical node determiner 212 of the program-derived semantic graph constructor 204 of the illustrated example of FIG. 2 iterates through the parse tree and determines the syntactical nodes present in the parse tree. The syntactical node determiner 212 saves the syntactical nodes to a temporary location. In some examples, the parse tree includes nodes that include syntactical values (e.g., mathematical operations, integers, if-else statements, etc.).

The example abstraction level modifier 216 of the program-derived semantic graph constructor 204 of the illustrated example of FIG. 2 sets the abstraction level to a default starting value (e.g., 0, 1, 10, etc.). In the following examples, the default starting value will be 0. The example leaf node creator 220 of the program-derived semantic graph constructor 204 sets the syntactical nodes identified by the syntactical node determiner 212 as leaf nodes in the program-derived semantic graph. The abstraction level modifier 216 increases the current value of the abstraction level.

The example abstraction level determiner 224 of the program-derived semantic graph constructor 204 of the illustrated example of FIG. 2 determines whether abstraction levels have been defined in the program-derived semantic graph. In some examples, abstraction levels are defined when child nodes are connected to a common parent node. In other examples, abstraction levels are defined when the most abstract abstraction level defined includes the nodes “Operations for Handling Data” and “Code Structure and Flow.” In these examples, the node “Operations for Handling Data” points to children nodes such as algorithms, mathematical operations, integers, etc. Also in these examples, the node “Code Structure and Flow” points to children nodes such as conditional statements, return statements, comparisons, etc.

The abstraction level determiner 224 determines whether the current abstraction level is deterministic. In some examples, a deterministic abstraction level describes an abstraction level where nodes with a parent on the abstraction level only point to a single parent. For example, the nodes while, for, and do while will only map to the singular parent node loop. Also in these examples, a non-deterministic abstraction level describes an abstraction level where at least one node that points to a parent on the current abstraction level, points to at least two parents on the current abstraction level.

The example rule-based abstraction level creator 228 of the program-derived semantic graph constructor 204 of the illustrated example of FIG. 2 creates a node set containing of the nodes to be used at the current abstraction level of the program-derived semantic graph. In some examples, the rule-based abstraction level creator 228 accesses the nodes currently present in the program-derived semantic graph at lower abstraction levels and determines whether the nodes have parent nodes at the current abstraction level. In these examples, the rule-based abstraction level creator 228 has a set of the possible nodes at the current abstraction level and determines the nodes in lower abstraction levels in the program-derived semantic graph that have a parent in the set of the possible nodes at the current abstraction level. For example, if the set of the possible nodes at the current abstraction level contains the node “Arithmetic Operations” and the set of nodes in lower abstraction levels of the program-derived semantic graph contains the node %, the rule-based abstraction level creator 228 would add the node “Arithmetic Operations” to the program-derived semantic graph at the current abstraction level.

The example learning-based abstraction level creator 232 of the program-derived semantic graph constructor 204 of the illustrated example of FIG. 2 creates a node set containing the nodes to be used at the current abstraction level of the program-derived semantic graph. In some examples, the learning-based abstraction level creator 232 accesses a set of possible nodes at the current abstraction level of the program-derived semantic graph. In these examples, since the abstraction level has been determined to be non-deterministic, at least one node in the set of nodes in lower abstraction levels of the program-derived semantic graph has multiple possible parent nodes in the set of possible nodes at the current abstraction level of the program-derived semantic graph.

In some examples, the learning-based abstraction level creator 232 is a multi-label classification model (e.g., decision tree, deep neural network, etc.). In these examples, the learning-based abstraction level creator 232 determines which of the nodes in the set of possible nodes at the current abstraction level of the program-derived semantic graph to include in the set of nodes at the current abstraction level of the program-derived semantic graph. In these examples, the learning-based abstraction level creator 232 identifies which nodes could be included in the set of nodes at the current abstraction level of the program-derived semantic graph and determines which nodes to include in the set of nodes at the current abstraction level of the program-derived semantic graph.

In some examples, the input to the learning-based abstraction level creator 232 is the set of nodes at lower abstraction levels in the program-derived semantic graph. In other examples, a weight is applied to nodes at lower abstraction levels in the program-derived semantic graph. In these examples, the input to the learning-based abstraction level creator 232 is the set of nodes in lower abstraction levels of the program-derived semantic graph that satisfy a weight threshold. In some examples, the weight threshold is a weight value which compares the weight of a node to the weight value. For example, if the weight value is set to 0.8, nodes in lower abstraction levels of the program-derived semantic graph with a weight greater than 0.8 would be in the input to the learning-based abstraction level creator 232.

In other examples, the input to the learning-based abstraction level creator 232 could be a percentage or amount of the highest weight nodes in the lower abstraction levels of the program-derived semantic graph. For example, the learning-based abstraction level creator 232 could retrieve the 30 nodes with the highest weight in the set of nodes in the lower abstraction levels. In another example, the learning-based abstraction level creator 232 could retrieve the heaviest 30% of nodes in the set of nodes in the lower abstraction levels. For example, if there are 50 nodes in the lower abstraction levels of the program-derived semantic graph, the learning-based abstraction level creator 232 could grab the 15 nodes with the largest weights. After the learning-based abstraction level creator 232 creates the set of nodes to include in the program-derived semantic graph at the current abstraction level, the process proceeds to the next abstraction level.

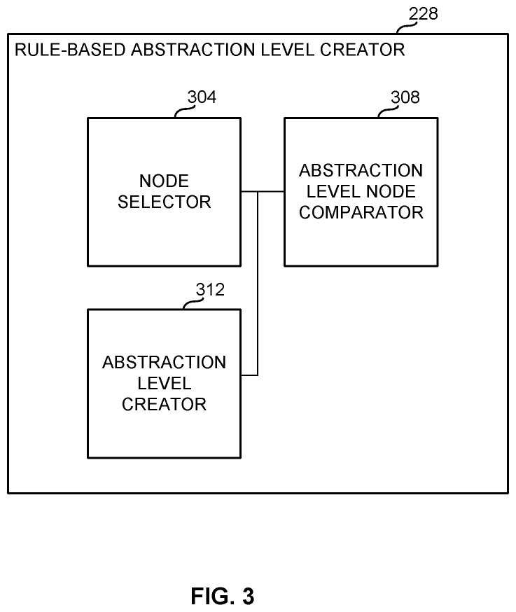

FIG. 3 is a block diagram representing an example implementation of the rule-based abstraction level creator 228 of FIG. 2. The rule-based abstraction level creator 228 creates an abstraction level based on input nodes and a set of possible nodes at the current abstraction level. The rule-based abstraction level creator 228 includes an example node selector 304, an example abstraction level node comparator 308, and an example abstraction level creator 312.

The example node selector 304 of the rule-based abstraction level creator 228 of the illustrated example of FIG. 3 determines whether there are remaining input nodes in the data structure. In response to determining the data structure contains input nodes, the node selector 304 selects one of the input nodes from the data structure.

The example abstraction level node comparator 308 of the rule-based abstraction level creator 228 of the illustrated example of FIG. 3 determines whether the selected input node maps to any of the possible nodes at the current abstraction level. In some examples, the abstraction level node comparator 308 contains sets for the abstraction levels containing possible nodes at the specified abstraction level. For example, if the set of the possible nodes at the current abstraction level contains the node “Arithmetic Operations” and the set of nodes in lower abstraction levels of the program-derived semantic graph contains the node %, the rule-based abstraction level creator 228 adds the node “Arithmetic Operations” to the program-derived semantic graph at the current abstraction level. If the abstraction level node comparator 308 determines that the selected input node maps to an identified node within the set of possible nodes at the current abstraction level, the identified node is added to the program-derived semantic graph. Else, the input node is ignored.

If the abstraction level node comparator 308 identifies a node to include at the current abstraction level, the example abstraction level creator 312 of the rule-based abstraction level creator 228 adds the identified node to the current abstraction level of the program-derived semantic graph. In some examples, the abstraction level creator 312 adds the identified node to a data structure (e.g., set, array, etc.) containing nodes that have been identified to be included at the current abstraction level. The node selector 304 removes the selected input node from the data structure created by the rule-based abstraction level creator 228.

If the abstraction level node comparator 308 does not identify a node to include at the current abstraction level, the abstraction level creator 312 ignores the selected input node. The node selector 304 removes the selected input node from the data structure created by the rule-based abstraction level creator 228.

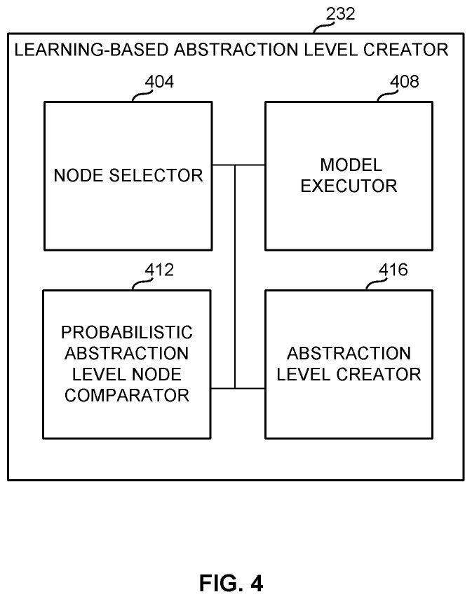

FIG. 4 is a block diagram representing an example implementation of the learning-based abstraction level creator 232 of FIG. 2. The learning-based abstraction level creator 232 creates an abstraction level for the program-derived semantic graph based on a set of input nodes and a set of possible nodes at the current abstraction level. In these examples, the learning-based abstraction level creator 232 creates abstraction levels that are found to be non-deterministic. The learning-based abstraction level creator 232 of the illustrated example of FIG. 4 includes an example node selector 404, an example model executor 408, an example probabilistic abstraction level node comparator 412, and an example abstraction level creator 416.

The example node selector 404 of the learning-based abstraction level creator 232 creates an input set, array, or other data structure containing the nodes in the program-derived semantic graph. In some examples, the node selector 404 selects nodes to include in the input set based on a weight of the nodes. In these examples, the nodes satisfying a weight threshold are included in the input set and the nodes not satisfying the weight threshold are not included in the input set. In other examples, the node selector 404 selects nodes in previous abstraction levels of the program-derived semantic graph to include in the input set. The nodes in the input set are considered input nodes. The node selector 404 selects one of the input nodes to compare to a set of possible nodes to include at the current abstraction level.

The node selector 404 determines whether there are remaining input nodes in the data structure. In response to determining the data structure contains input nodes, the node selector 404 selects one of the input nodes from the data structure.

The example probabilistic abstraction level node comparator 412 of the learning-based abstraction level creator 232 determines whether the selected input node maps to any of the possible nodes at the current abstraction level. In some examples, the probabilistic abstraction level node comparator 412 contains sets for the abstraction levels containing possible nodes at the specified abstraction level. For example, if the set of the possible nodes at the current abstraction level contains the node “Arithmetic Operations” and the set of nodes in lower abstraction levels of the program-derived semantic graph contains the node %, the learning-based abstraction level creator 232 adds the node “Arithmetic Operations” to the program-derived semantic graph at the current abstraction level.

In other examples, the selected input node maps to more than one node at the currently selected abstraction level. In these examples, the probabilistic abstraction level node comparator 412 identifies possible parent nodes of the selected node. If the probabilistic abstraction level node comparator 412 determines that the selected input node maps to at least one identified node within the set of possible nodes at the current abstraction level, learning-based probabilistic abstraction level node comparator 412 determines one of the at least one identified nodes to add to the current abstraction level. Else, the input node is ignored.

If the probabilistic abstraction level node comparator 412 identifies at least one node to add to the current abstraction level, the example model executor 408 of the learning-based abstraction level creator 232 determines one of the at least one identified nodes to add to the current abstraction level of the program-derived semantic graph. In some examples, a machine learning classification model (e.g., decision tree, deep neural network, etc.) is used to determine which of the at least one identified nodes to add to the current abstraction level.

The example abstraction level creator 416 of the learning-based abstraction level creator 232 adds the identified node to the current abstraction level of the program-derived semantic graph. In some examples, the abstraction level creator 416 adds the identified node to a data structure (e.g., set, array, etc.) containing nodes that have been identified to be included at the current abstraction level. The node selector 404 removes the selected input node from the data structure created by the learning-based abstraction level creator 232.

If the probabilistic abstraction level node comparator 412 does not identify a node to include at the current abstraction level, the abstraction level creator 416 ignores the selected input node. The node selector 404 removes the selected input node from the data structure created by the learning-based abstraction level creator 232.

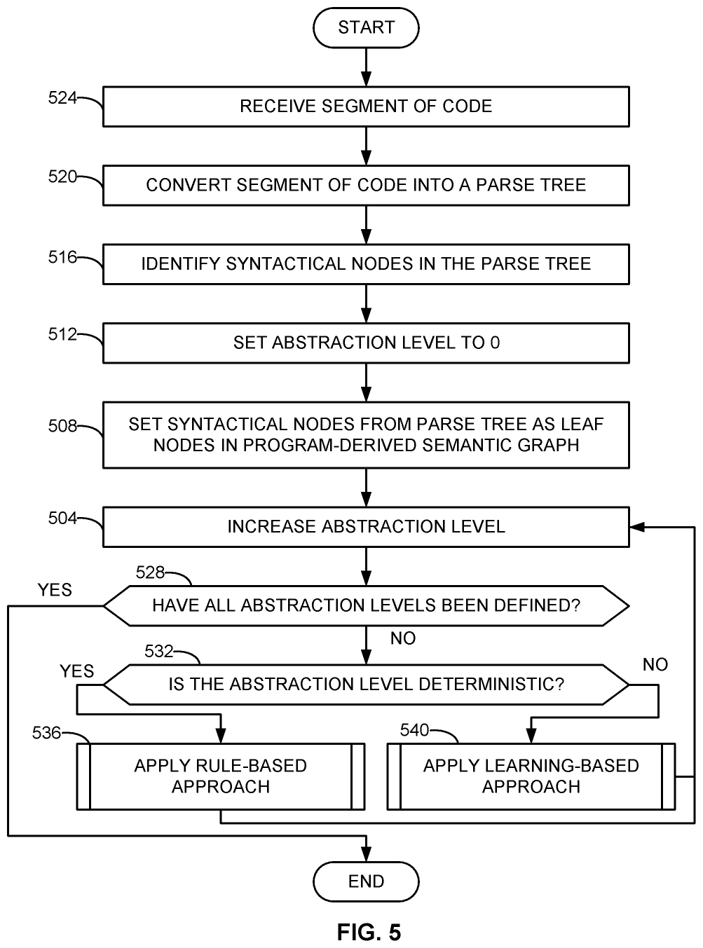

While an example manner of implementing the program-derived semantic graph constructor 204 of FIG. 2 is illustrated in FIG. 5, one or more of the elements, processes and/or devices illustrated in FIG. 5 may be combined, divided, re-arranged, omitted, eliminated and/or implemented in any other way. Further, the example parse tree constructor 208, the example syntactical node determiner 212, the example abstraction level modifier 216, the example leaf node creator 220, the example abstraction level determiner 224, the example rule-based abstraction level creator 228, the example learning-based abstraction level creator 232, the example program-derived graph comparator 236, the example node selector 304, the example abstraction level node comparator 308, the example abstraction level creator 312, the example node selector 404, the example model executor 408, the example probabilistic abstraction level node comparator 412, and the example abstraction level creator 416 and/or, more generally, the example program-derived graph constructor 204 of FIG. 2 may be implemented by hardware, software, firmware and/or any combination of hardware, software and/or firmware. Thus, for example, any of the example parse tree constructor 208, the example syntactical node determiner 212, the example abstraction level modifier 216, the example leaf node creator 220, the example abstraction level determiner 224, the example rule-based abstraction level creator 228, the example learning-based abstraction level creator 232, the example program-derived graph comparator 236, the example node selector 304, the example abstraction level node comparator 308, the example abstraction level creator 312, the example node selector 404, the example model executor 408, the example probabilistic abstraction level node comparator 412, and the example abstraction level creator 416 and/or, more generally, the example program-derived graph constructor 204 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example parse tree constructor 208, the example syntactical node determiner 212, the example abstraction level modifier 216, the example leaf node creator 220, the example abstraction level determiner 224, the example rule-based abstraction level creator 228, the example learning-based abstraction level creator 232, the example program-derived graph comparator 236, the example node selector 304, the example abstraction level node comparator 308, the example abstraction level creator 312, the example node selector 404, the example model executor 408, the example probabilistic abstraction level node comparator 412, and the example abstraction level creator 416 is/are hereby expressly defined to include a non-transitory computer readable storage device or storage disk such as a memory, a digital versatile disk (DVD), a compact disk (CD), a Blu-ray disk, etc. including the software and/or firmware. Further still, the example program-derived graph constructor 204 of FIG. 2 may include one or more elements, processes and/or devices in addition to, or instead of, those illustrated in FIG. 5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

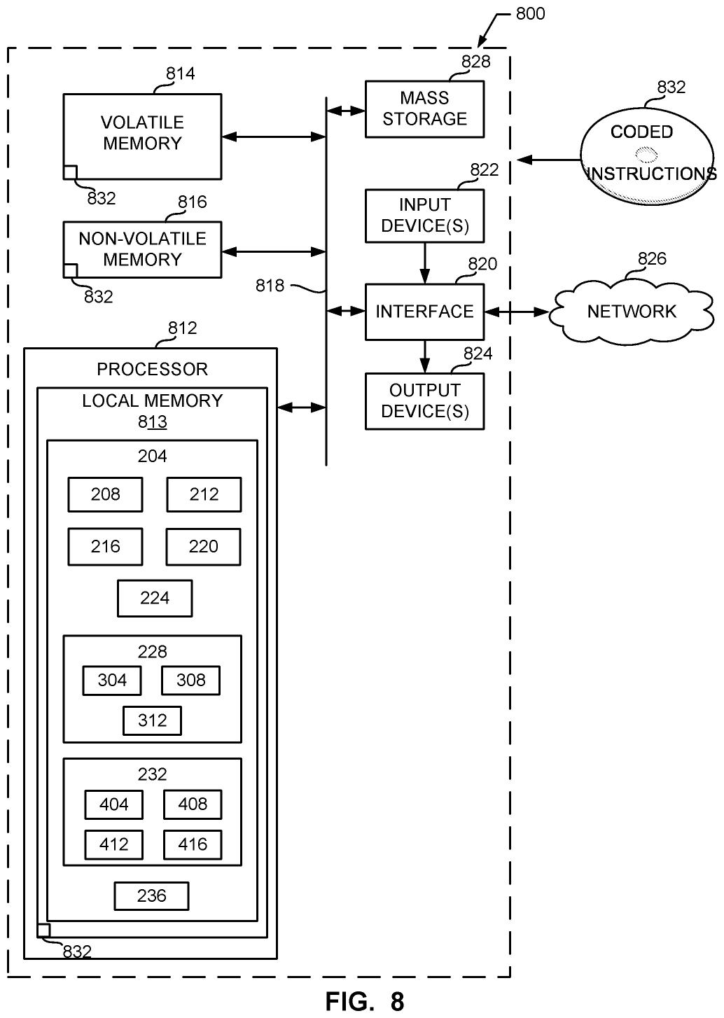

A flowchart representative of example hardware logic, machine readable instructions, hardware implemented state machines, and/or any combination thereof for implementing the program-derived graph constructor 204 of FIG. 2 is shown in FIG. 5. The machine readable instructions may be one or more executable programs or portion(s) of an executable program for execution by a computer processor and/or processor circuitry, such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 5, many other methods of implementing the example program-derived graph constructor 204 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5, 6, and 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 5 is a flowchart representative of machine-readable instructions which may be executed to implement the program-derived graph constructor 204 of FIG. 2. The program-derived graph constructor 204 accesses a segment or snippet of program code. (Block 504). The program code can be from any coding language (e.g., Java, C, C++, Python, etc.).

The parse tree constructor 208 converts the segment or snippet of program code into a parse tree. (Block 508). In some examples, the parse tree includes the words, mathematical operations, and/or formatting present in the segment or snippet of program code. In some examples, the parse tree includes nodes that are syntactical values (e.g., mathematical operations, integers, if-else statements, etc.).

The syntactical node determiner 212 iterates through the parse tree and determines the syntactical nodes present in the parse tree. (Block 512). The syntactical node determiner 212 saves the syntactical nodes to a temporary location. In some examples, the parse tree includes nodes that include syntactical values (e.g., mathematical operations, integers, if-else statements, etc.).

The abstraction level modifier 216 sets the abstraction level to a default starting value (e.g., zero, one, ten, etc.). (Block 516). In the following examples, the default starting value will be 0. The leaf node creator 220 sets the syntactical nodes identified by the syntactical node determiner 212 as leaf nodes in the program-derived semantic graph. (Block 520). The abstraction level modifier 216 increases the current value of the abstraction level. (Block 524).

The abstraction level determiner 224 determines whether abstraction levels have been defined in the program-derived semantic graph. (Block 528). In some examples, abstraction levels are defined when child nodes are connected to a common parent node. In other examples, abstraction levels are defined when the most abstract abstraction level defined includes the nodes “Operations for Handling Data” and “Code Structure and Flow”. In these examples, the node “Operations for Handling Data” points to children nodes such as algorithms, mathematical operations, integers, etc. Also in these examples, the node “Code Structure and Flow” points to children nodes such as conditional statements, return statements, comparisons, etc. If the abstraction level determiner 224 determines abstraction levels have been defined, the process ends. If the abstraction level determiner 224 determines abstraction levels are not defined, the process proceeds to determine whether the current abstraction level is deterministic.

The abstraction level determiner 224 determines whether the current abstraction level is deterministic. (Block 532). In some examples, a deterministic abstraction level describes an abstraction level where nodes with a parent on the abstraction level only point to a single parent. For example, the nodes while, for, and do while will only map to the singular parent node loop. Also in these examples, a non-deterministic abstraction level describes an abstraction level where at least one node that points to a parent on the current abstraction level, points to at least two parents on the current abstraction level. If the abstraction level determiner 224 determines the current abstraction level to be deterministic, a rule-based approach is utilized to create the current abstraction level. If the abstraction level determiner 224 determines the current abstraction level to be non-deterministic, a learning-based approach is utilized to create the current abstraction level.

The rule-based abstraction level creator 228 creates a node set containing of the nodes to be used at the current abstraction level of the program-derived semantic graph. (Block 536). In some examples, the rule-based abstraction level creator 228 accesses the nodes currently present in the program-derived semantic graph at lower abstraction levels and determines whether the nodes have parent nodes at the current abstraction level. In these examples, the rule-based abstraction level creator 228 has a set of the possible nodes at the current abstraction level and determines the nodes in lower abstraction levels in the program-derived semantic graph that have a parent in the set of the possible nodes at the current abstraction level. For example, if the set of the possible nodes at the current abstraction level contains the node “Arithmetic Operations” and the set of nodes in lower abstraction levels of the program-derived semantic graph contains the node %, the rule-based abstraction level creator 228 would add the node “Arithmetic Operations” to the program-derived semantic graph at the current abstraction level. Once the rule-based abstraction level creator 228 iterates through the set of nodes in lower abstraction levels of the program-derived semantic graph and determines the nodes to include at the current abstraction level, the process proceeds to the next abstraction level.

The learning-based abstraction level creator 232 creates a node set containing the nodes to be used at the current abstraction level of the program-derived semantic graph. (Block 540). In some examples, the learning-based abstraction level creator 232 accesses a set of possible nodes at the current abstraction level of the program-derived semantic graph. In these examples, a non-deterministic abstraction level indicates that at least one node in the set of nodes in lower abstraction levels of the program-derived semantic graph has multiple possible parent nodes in the set of possible nodes at the current abstraction level of the program-derived semantic graph.

In some examples, the learning-based abstraction level creator 232 is a multi-label classification model (e.g., decision tree, deep neural network, etc.). In these examples, the learning-based abstraction level creator 232 determines which of the nodes in the set of possible nodes at the current abstraction level of the program-derived semantic graph to include in the set of nodes at the current abstraction level of the program-derived semantic graph. In these examples, the learning-based abstraction level creator 232 identifies which nodes could be included in the set of nodes at the current abstraction level of the program-derived semantic graph and determines which nodes to include in the set of nodes at the current abstraction level of the program-derived semantic graph.

In some examples, the input to the learning-based abstraction level creator 232 is the set of nodes at lower abstraction levels in the program-derived semantic graph. In other examples, a weight is applied to nodes at lower abstraction levels in the program-derived semantic graph. In these examples, the input to the learning-based abstraction level creator 232 is the set of nodes in lower abstraction levels of the program-derived semantic graph that satisfy a weight threshold. In some examples, the weight threshold is a weight value which compares the weight of a node to the weight value. For example, if the weight value is set to 0.8, nodes in lower abstraction levels of the program-derived semantic graph with a weight greater than 0.8 would be in the input to the learning-based abstraction level creator 232.

In other examples, the input to the learning-based abstraction level creator 232 could be a percentage or amount of the highest weight nodes in the lower abstraction levels of the program-derived semantic graph. For example, the learning-based abstraction level creator 232 could retrieve the 30 nodes with the highest weight in the set of nodes in the lower abstraction levels. In another example, the learning-based abstraction level creator 232 could retrieve the heaviest 30% of nodes in the set of nodes in the lower abstraction levels. For example, if there are 50 nodes in the lower abstraction levels of the program-derived semantic graph, the learning-based abstraction level creator 232 could grab the 15 nodes with the largest weights. After the learning-based abstraction level creator 232 creates the set of nodes to include in the program-derived semantic graph at the current abstraction level, the process proceeds to the next abstraction level.

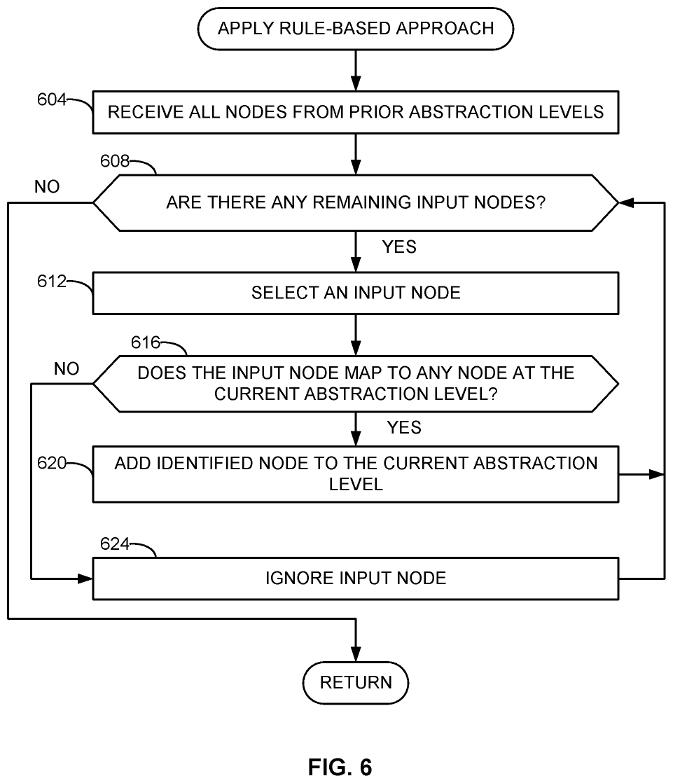

FIG. 6 is a flowchart representative of machine-readable instructions which may be executed to implement the rule-based abstraction level creator 228 of FIGS. 2 and 3. The rule-based abstraction level creator 228 accesses the nodes from prior abstraction levels. (Block 604). In some examples, the nodes from prior abstraction levels are put into a set, array, or other data structure. The nodes from prior abstraction levels are the input nodes to the rule-based abstraction level creator 228.

The node selector 304 determines whether there are remaining input nodes in the data structure. (Block 608). In response to determining that the data structure does not contain input nodes, the process ends. In response to determining the data structure contains input nodes, the node selector 304 selects one of the input nodes from the data structure. (Block 612).

The abstraction level node comparator 308 determines whether the selected input node maps to any of the possible nodes at the current abstraction level. (Block 616). In some examples, the abstraction level node comparator 308 contains sets for the abstraction levels containing possible nodes at the specified abstraction level. For example, if the set of the possible nodes at the current abstraction level contains the node “Arithmetic Operations” and the set of nodes in lower abstraction levels of the program-derived semantic graph contains the node %, the rule-based abstraction level creator 228 would add the node “Arithmetic Operations” to the program-derived semantic graph at the current abstraction level. If the abstraction level node comparator 308 determines that the selected input node maps to an identified node within the set of possible nodes at the current abstraction level, the identified node is added to the program-derived semantic graph. Else, the input node is ignored.

If the abstraction level node comparator 308 identifies a node to include at the current abstraction level, the abstraction level creator 312 adds the identified node to the current abstraction level of the program-derived semantic graph. (Block 620). In some examples, the abstraction level creator 312 adds the identified node to a data structure (e.g., set, array, etc.) containing nodes that have been identified to be included at the current abstraction level. The node selector 304 removes the selected input node from the data structure created by the rule-based abstraction level creator 228.

If the abstraction level node comparator 308 does not identify a node to include at the current abstraction level, the abstraction level creator 312 ignores the selected input node. (Block 624). The node selector 304 removes the selected input node from the data structure created by the rule-based abstraction level creator 228.

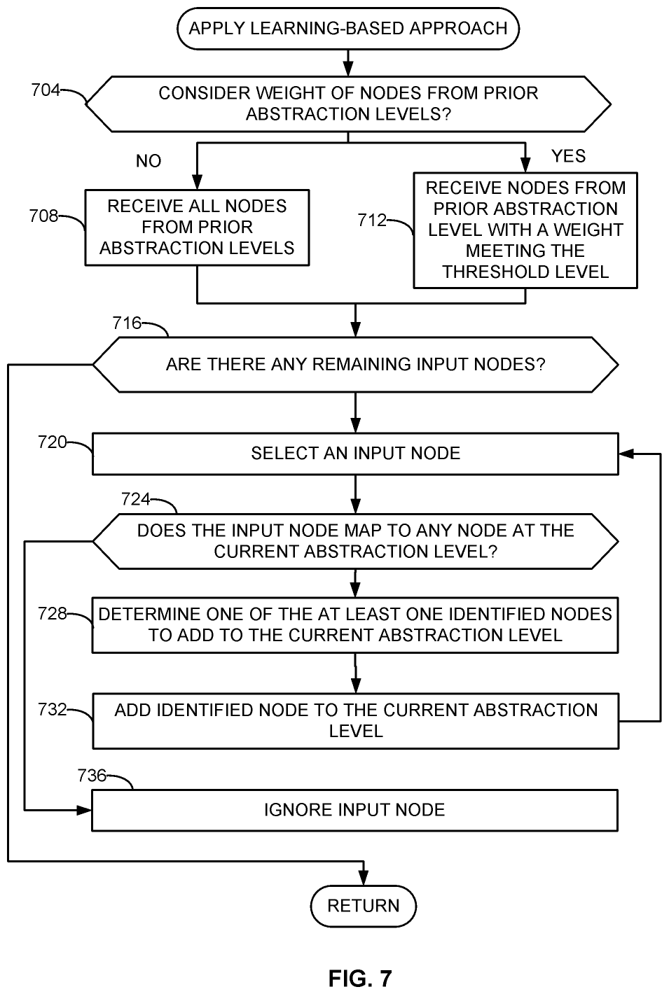

FIG. 7 is a flowchart representative of machine-readable instructions which may be executed to implement the learning-based abstraction level creator 232 of FIGS. 2 and 4. The learning-based abstraction level creator 232 accesses nodes currently in the program-derived semantic graph. The learning-based abstraction level creator 232 determines whether to consider the weight of the nodes in the program-derived semantic graph. (Block 704).

In response to determining not to consider the weight of the nodes in the program-derived semantic graph, the learning-based abstraction level creator 232 accesses nodes in the program-derived semantic graph. (Block 708). The node selector 404 creates an input set, array, or other data structure containing the nodes in the program-derived semantic graph. The nodes in the input set are considered input nodes.

In response to determining to consider the weight of the nodes in the program-derived semantic graph, the learning-based abstraction level creator 232 accesses nodes in the program-derived semantic graph meeting a weight threshold. (Block 712). In some examples, the weight threshold is a value. For example, the weight threshold is 0.7 then nodes in the program-derived semantic graph with a weight greater than 0.7 would be accessed. In other examples, the weight threshold is the nodes in the program-derived semantic graph in a top pre-determined percentage or value of weights. For example, if the weight threshold is thirty percent, in a situation with fifty nodes, the 15 nodes with the largest weight would be the input nodes. For another example, if the weight threshold is the top thirty heaviest nodes, then the thirty nodes with the largest weights would be selected as input nodes. The node selector 404 creates an input set, array, or other data structure containing the nodes in the program-derived semantic graph. The nodes in the input set are considered input nodes.

The node selector 404 determines whether there are remaining input nodes in the data structure. (Block 716). In response to determining that the data structure does not contain input nodes, the process ends. In response to determining the data structure contains input nodes, the node selector 404 selects one of the input nodes from the data structure. (Block 720).

The probabilistic abstraction level node comparator 412 determines whether the selected input node maps to any of the possible nodes at the current abstraction level. (Block 724). In some examples, the probabilistic abstraction level node comparator 412 contains sets for the abstraction levels containing possible nodes at the specified abstraction level. For example, if the set of the possible nodes at the current abstraction level contains the node “Arithmetic Operations” and the set of nodes in lower abstraction levels of the program-derived semantic graph contains the node %, the learning-based abstraction level creator 232 would add the node “Arithmetic Operations” to the program-derived semantic graph at the current abstraction level.

In other examples, the selected input node could map to more than one node at the currently selected abstraction level. In these examples, the probabilistic abstraction level node comparator 412 identifies possible parent nodes of the selected node. If the probabilistic abstraction level node comparator 412 determines that the selected input node maps to at least one identified node within the set of possible nodes at the current abstraction level, learning-based probabilistic abstraction level node comparator 412 determines one of the at least one identified nodes to add to the current abstraction level. Else, the input node is ignored.

If the probabilistic abstraction level node comparator 412 identifies at least one node to add to the current abstraction level, the model executor 408 determines one of the at least one identified nodes to add to the current abstraction level of the program-derived semantic graph. (Block 728). In some examples, a machine learning classification model (e.g., decision tree, deep neural network, etc.) is used to determine which of the at least one identified nodes to add to the current abstraction level.

The abstraction level creator 416 adds the identified node to the current abstraction level of the program-derived semantic graph. (Block 732). In some examples, the abstraction level creator 416 adds the identified node to a data structure (e.g., set, array, etc.) containing nodes that have been identified to be included at the current abstraction level. The node selector 404 removes the selected input node from the data structure created by the learning-based abstraction level creator 232.

If the probabilistic abstraction level node comparator 412 does not identify a node to include at the current abstraction level, the abstraction level creator 416 ignores the selected input node. (Block 736). The node selector 404 removes the selected input node from the data structure created by the learning-based abstraction level creator 232.

FIG. 8 is a block diagram of an example processor platform 800 structured to execute the instructions of FIGS. 5, 6, and 7 to implement the apparatus of FIGS. 2, 3, and 4. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example program-derived graph constructor 204, the example parse tree constructor 208, the example syntactical node determiner 212, the example abstraction level modifier 216, the example leaf node creator 220, the example abstraction level determiner 224, the example rule-based abstraction level creator 228, the example learning-based abstraction level creator 232, the example program-derived graph comparator 236, the example node selector 304, the example abstraction level node comparator 308, the example abstraction level creator 312, the example node selector 404, the example model executor 408, the example probabilistic abstraction level node comparator 412, and the example abstraction level creator 416.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 5, 6, and 7 may be stored in the mass storage device 828, in the volatile memory 814, in the non-volatile memory 816, and/or on a removable non-transitory computer readable storage medium such as a CD or DVD.

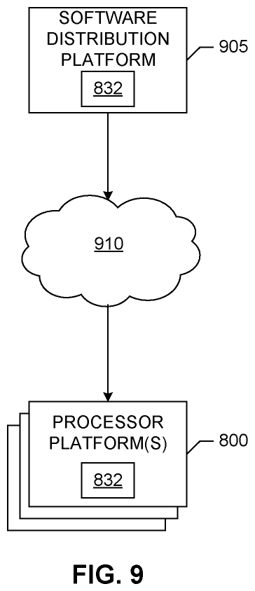

A block diagram illustrating an example software distribution platform 905 to distribute software such as the example computer readable instructions 832 of FIG. 8 to third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 832 of FIG. 8. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the computer readable instructions 832, which may correspond to the example computer readable instructions of FIG. 5, 6, or 7, as described above. The one or more servers of the example software distribution platform 905 are in communication with a network 910, which may correspond to any one or more of the Internet and/or any of the example networks 826 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 832 from the software distribution platform 905. For example, the software, which may correspond to the example computer readable instructions of FIG. 5, 6 or 7, may be downloaded to the example processor platform 800, which is to execute the computer readable instructions 832 to implement the program-derived semantic graph constructor 204. In some example, one or more servers of the software distribution platform 905 periodically offer, transmit, and/or force updates to the software (e.g., the example computer readable instructions 832 of FIG. 8) to ensure improvements, patches, updates, etc. are distributed and applied to the software at the end user devices.

From the foregoing, it will be appreciated that example methods, apparatus and articles of manufacture have been disclosed that construct program-derived semantic graphs. The disclosed methods, apparatus and articles of manufacture improve the efficiency of using a computing device by allowing for comparisons between code snippets based on program-derived semantic graphs, code suggestions for developers during the coding process, and protecting against plagiarism of coding programs. The disclosed methods, apparatus and articles of manufacture are accordingly directed to one or more improvement(s) in the functioning of a computer.

Example methods, apparatus, systems, and articles of manufacture to construct program-derived semantic graphs are disclosed herein. Further examples and combinations thereof include the following:

Example 1 includes an apparatus to construct and compare program-derived semantic graphs (PSGs), the apparatus comprising a leaf node creator to identify a first set of nodes within a parse tree, and set a first abstraction level of the PSG to include the first set of nodes, an abstraction level determiner to access a second set of nodes, wherein the second set of nodes is the set of nodes in the PSG, create a third set of nodes, the third set of nodes to include possible nodes at a current abstraction level, and determine whether the current abstraction level is deterministic, a rule-based abstraction level creator to in response to determining the current abstraction level is deterministic, construct the current abstraction level, and a PSG comparator to access a first PSG and a second PSG, and determine if the first PSG and the second PSG satisfy a similarity threshold.

Example 2 includes the apparatus of example 1, wherein the first set of nodes is a set of syntactic nodes in the parse tree.

Example 3 includes the apparatus of example 1, wherein an abstraction level is deterministic when at least one node in the second set of nodes has at least two possible parent nodes in the third set of nodes.

Example 4 includes the apparatus of example 1, wherein to construct the current abstraction level, the rule-based abstraction level creator is to access the second set of nodes and the third set of nodes, determine a fourth set of nodes within the third set of nodes that are parents of at least one node in the second set of nodes, and set the current abstraction level to include the fourth set of nodes.

Example 5 includes the apparatus of example 1, including a learning-based abstraction level creator to in response to determining the current abstraction level is not deterministic, create a fourth set of nodes, wherein to create the fourth set of nodes, the learning-based abstraction level creator is to identify nodes within the second set of nodes with one possible parent node in the third set of nodes, add identified parent nodes to the fourth set of nodes, identify nodes within the second set of nodes with at least two possible parent nodes in the third set of nodes, and determine one of the at least two possible parent nodes to add to the fourth set of nodes, and set the fourth set of nodes as the current abstraction level in the PSG.

Example 6 includes the apparatus of example 1, wherein the second set of nodes is a set of nodes that satisfy a weight threshold.

Example 7 includes the apparatus of example 1, including a parse tree creator to access a code snippet, and construct a parse tree based on the code snippet.

Example 8 includes At least one non-transitory computer readable medium comprising instructions that, when executed, cause a computing device to identify a first set of nodes within a parse tree, set a first abstraction level of a program-derived semantic graph (PSG) to include the first set of nodes, access a second set of nodes, the second set of nodes to include the set of nodes in the PSG, create a third set of nodes, the third set of to include possible nodes at a current abstraction level, determine whether a current abstraction level is deterministic, in response to determining the current abstraction level is deterministic, construct the current abstraction level, access a first PSG and a second PSG, and determine whether the first PSG and the second PSG satisfy a similarity threshold.

Example 9 includes the at least one non-transitory computer readable medium of example 8, wherein the first set of nodes is a set of syntactic nodes in the parse tree.

Example 10 includes the at least one non-transitory computer readable medium of example 8, wherein the current abstraction level is deterministic when at least one node in the second set of nodes has at least two possible parent nodes in the third set of nodes.

Example 11 includes the at least one non-transitory computer readable medium of example 8, wherein the instructions, when executed, cause the computing device, in order to construct the current abstraction level, to access the second set of nodes and the third set of nodes and determine a fourth set of nodes within the third set of nodes that are parents of at least one node in the second set of nodes, and set the current abstraction level to include the fourth set of nodes.

Example 12 includes the at least one non-transitory computer readable medium of example 8, wherein the instructions, when executed, cause the computing device to in response to determining the current abstraction level is not deterministic, create a fourth set of nodes, wherein to create the fourth set of nodes, the computing device is to identify nodes within the second set of nodes with one possible parent node in the third set of nodes, add identified parent nodes to the fourth set of nodes, identify nodes within the second set of nodes with at least two possible parent nodes in the third set of nodes, and determine one of the at least two possible parent nodes to add to the fourth set of nodes, and set the fourth set of nodes as the current abstraction level in the PSG.

Example 13 includes the at least one non-transitory computer readable medium of example 12, wherein the second set of nodes is a set of nodes that satisfy a weight threshold.

Example 14 includes the at least one non-transitory computer readable medium of example 8, wherein the instructions, when executed, cause the computing device to access a code snippet, and construct a parse tree based on the code snippet.

Example 15 includes a method for construction a program-derived semantic graph (PSG), the method comprising identifying a first set of nodes within a parse tree, setting a first abstraction level of a program-derived semantic graph (PSG) to contain the first set of nodes, accessing a second set of nodes, the second set of nodes to include the set of nodes in the PSG, creating a third set of nodes, the third set of nodes to include possible nodes at a current abstraction level, determining whether a current abstraction level is deterministic, in response to determining the current abstraction level is deterministic, constructing the current abstraction level, accessing a first PSG and a second PSG, and determining whether the first PSG and the second PSG satisfy a similarity threshold.

Example 16 includes the method of example 15, wherein the first set of nodes is a set of syntactic nodes in the parse tree.

Example 17 includes the method of example 15, wherein the current abstraction level is deterministic when at least one node in the second set of nodes has at least two possible parent nodes in the third set of nodes.

Example 18 includes the method of example 15, wherein the construction of the current abstraction level includes accessing the second set of nodes and the third set of nodes, determining a fourth set of nodes within the third set of nodes that are parents of at least one node in the second set of nodes, and setting the current abstraction level to include the fourth set of nodes.

Example 19 includes the method of example 15, further including in response to determining the current abstraction level is not deterministic, creating a fourth set of nodes by identifying nodes within the second set of nodes with one possible parent node in the third set of nodes, adding identified parent nodes to the fourth set of nodes, identifying nodes within the second set of nodes with at least two possible parent nodes in the third set of nodes, and determining one of the at least two possible parent nodes to add to the fourth set of nodes, and setting the fourth set of nodes as the current abstraction level in the PSG.

Example 20 includes the method of example 19, wherein the second set of nodes is a set of nodes that satisfy a weight threshold.

Example 21 includes the method of example 15, further including accessing a code snippet, and constructing a parse tree based on the code snippet.

Example 22 includes a computer system to construct and compare program-derived semantic graphs (PSGs) comprising memory, and one or more processors to execute instructions to cause the one or more processors to identify a first set of nodes within a parse tree, set a first abstraction level of a program-derived semantic graph (PSG) to contain the first set of nodes, access a second set of nodes, the second set of nodes to include the set of nodes in the PSG, create a third set of nodes, the third set of nodes to include the possible nodes at a current abstraction level, determine whether a current abstraction level is deterministic, in response to determining the current abstraction level is deterministic, construct the current abstraction level, access a first PSG and a second PSG, and determine whether the first PSG and the second PSG satisfy a similarity threshold.

Example 23 includes the computer system of example 22, wherein the first set of nodes is a set of syntactic nodes in the parse tree.

Example 24 includes the computer system of example 22, wherein the current abstraction level is deterministic when at least one node in the second set of nodes has at least two possible parent nodes in the third set of nodes.

Example 25 includes the computer system of example 22, wherein the construction of the current abstraction level includes accessing the second set of nodes and the third set of nodes and determine a fourth set of nodes within the third set of nodes that are parents of at least one node in the second set of nodes, and setting the current abstraction level to include the fourth set of nodes.

Example 26 includes the computer system of example 22, further including a learning-based abstraction level creator to in response to determining the current abstraction level is not deterministic, create a fourth set of nodes, wherein the learning-based abstraction level creator is to identify nodes within the second set of nodes with one possible parent node in the third set of nodes, add identified parent nodes to the fourth set of nodes, identify nodes within the second set of nodes with at least two possible parent nodes in the third set of nodes, and determine one of the at least two possible parent nodes to add to the fourth set of nodes, and set the fourth set of nodes as the current abstraction level in the PSG.

Example 27 includes the computer system of example 26, wherein the second set of nodes is a set of nodes that satisfy a weight threshold.

Example 28 includes the computer system of example 22, including accessing a code snippet, and constructing a parse tree based on the code snippet.

Example 29 includes an apparatus for construction a program-derived semantic graph (PSG), the apparatus comprising means for a leaf node creator to, identify a first set of nodes within a parse tree, set a first abstraction level of a program-derived semantic graph (PSG) to contain the first set of nodes, means for an abstraction level determiner to access a second set of nodes, the second set of nodes to include the set of nodes in the PSG, create a third set of nodes, the third set of nodes to include the possible nodes at a current abstraction level, determine whether a current abstraction level is deterministic, means for a rule-based abstraction level creator to in response to determining the current abstraction level is deterministic, construct the current abstraction level, means for a PSG comparator to access a first PSG and a second PSG, and determine whether the first PSG and the second PSG satisfy a similarity threshold.

Example 30 includes the apparatus of example 29, wherein the first set of nodes is a set of syntactic nodes in the parse tree.

Example 31 includes the apparatus of example 29, wherein the current abstraction level is deterministic when at least one node in the second set of nodes has at least two possible parent nodes in the third set of nodes.

Example 32 includes the apparatus of example 29, wherein the construction of the current abstraction level includes means for the rule-based abstraction level creator to access the second set of nodes and the third set of nodes, determine a fourth set of nodes within the third set of nodes that are parents of at least one node in the second set of nodes, and set the current abstraction level to include the fourth set of nodes.

Example 33 includes the apparatus of example 29, including means for a learning-based abstraction level creator to, in response to determining the current abstraction level is not deterministic, create a fourth set of nodes, wherein to create the fourth set of nodes the learning-based abstraction level creator is to identify nodes within the second set of nodes with one possible parent node in the third set of nodes, add identified parent nodes to the fourth set of nodes, identify nodes within the second set of nodes with at least two possible parent nodes in the third set of nodes, and determine one of the at least two possible parent nodes to add to the fourth set of nodes, and means for setting the fourth set of nodes as the current abstraction level in the PSG.

Example 34 includes the apparatus of example 33, wherein the second set of nodes is a set of nodes that satisfy a weight threshold.

Example 35 includes the apparatus of example 29, including means for accessing a code snippet, and means for constructing a parse tree based on the code snippet.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus to construct and compare program-derived semantic graphs, the apparatus comprising:
a leaf node creator to:
identify a first set of nodes within a parse tree; and
set a first abstraction level of a program-derived semantic graph (PSG) to include the first set of nodes;
an abstraction level determiner to:
access a second set of nodes, the second set of nodes to include nodes in the PSG;
create a third set of nodes, the third set of nodes to include possible nodes at a current abstraction level; and
determine whether the current abstraction level is deterministic;
a rule-based abstraction level creator to:
in response to determining the current abstraction level is deterministic, construct the current abstraction level; and
a PSG comparator to:
access a first PSG and a second PSG; and
determine if the first PSG and the second PSG satisfy a similarity threshold.

2. The apparatus of claim 1, wherein the first set of nodes is a set of syntactic nodes in the parse tree.

3. The apparatus of claim 1, wherein an abstraction level is deterministic when at least one node in the second set of nodes has at least two possible parent nodes in the third set of nodes.

4. The apparatus of claim 1, wherein to construct the current abstraction level, the rule-based abstraction level creator is to:
access the second set of nodes and the third set of nodes;
determine a fourth set of nodes within the third set of nodes that are parents of at least one node in the second set of nodes; and
set the current abstraction level to include the fourth set of nodes.

5. The apparatus of claim 1, including a learning-based abstraction level creator to:
in response to determining the current abstraction level is not deterministic, create a fourth set of nodes, wherein to create the fourth set of nodes, the learning-based abstraction level creator is to:
identify nodes within the second set of nodes with one possible parent node in the third set of nodes;
add identified parent nodes to the fourth set of nodes;
identify nodes within the second set of nodes with at least two possible parent nodes in the third set of nodes; and
determine one of the at least two possible parent nodes to add to the fourth set of nodes; and
set the fourth set of nodes as the current abstraction level in the PSG.

6. The apparatus of claim 1, wherein the second set of nodes is a set of nodes that satisfy a weight threshold.

7. The apparatus of claim 1, including a parse tree creator to:
access a code snippet; and
construct a parse tree based on the code snippet.

8. At least one non-transitory computer readable medium comprising instructions that, when executed, cause a computing device to:
identify a first set of nodes within a parse tree;
set a first abstraction level of a program-derived semantic graph (PSG) to include the first set of nodes;
access a second set of nodes, the second set of nodes to include nodes in the PSG;
create a third set of nodes, the third set of nodes to include possible nodes at a current abstraction level;
determine whether a current abstraction level is deterministic;
in response to determining the current abstraction level is deterministic, construct the current abstraction level;
access a first PSG and a second PSG; and
determine whether the first PSG and the second PSG satisfy a similarity threshold.

9. The at least one non-transitory computer readable medium of claim 8, wherein the first set of nodes is a set of syntactic nodes in the parse tree.

10. The at least one non-transitory computer readable medium of claim 8, wherein the current abstraction level is deterministic when at least one node in the second set of nodes has at least two possible parent nodes in the third set of nodes.

11. The at least one non-transitory computer readable medium of claim 8, wherein the instructions, when executed, cause the computing device, in order to construct the current abstraction level, to:
access the second set of nodes and the third set of nodes and determine a fourth set of nodes within the third set of nodes that are parents of at least one node in the second set of nodes; and
set the current abstraction level to include the fourth set of nodes.

12. The at least one non-transitory computer readable medium of claim 8, wherein the instructions, when executed, cause the computing device to:
in response to determining the current abstraction level is not deterministic, create a fourth set of nodes, wherein to create the fourth set of nodes, the computing device is to:
identify nodes within the second set of nodes with one possible parent node in the third set of nodes;
add identified parent nodes to the fourth set of nodes;
identify nodes within the second set of nodes with at least two possible parent nodes in the third set of nodes; and
determine one of the at least two possible parent nodes to add to the fourth set of nodes; and
set the fourth set of nodes as the current abstraction level in the PSG.

13. The at least one non-transitory computer readable medium of claim 12, wherein the second set of nodes is a set of nodes that satisfy a weight threshold.

14. The at least one non-transitory computer readable medium of claim 8, wherein the instructions, when executed, cause the computing device to:
access a code snippet; and
construct a parse tree based on the code snippet.

15. A method for constructing a program-derived semantic graphs, the method comprising:
identifying a first set of nodes within a parse tree;
setting a first abstraction level of a program-derived semantic graph (PSG) to contain the first set of nodes;
accessing a second set of nodes, the second set of nodes to include nodes in the PSG;
creating a third set of nodes, the third set of nodes to include possible nodes at a current abstraction level;
determining whether a current abstraction level is deterministic;
in response to determining the current abstraction level is deterministic, constructing the current abstraction level;
accessing a first PSG and a second PSG; and
determining whether the first PSG and the second PSG satisfy a similarity threshold.

16. The method of claim 15, wherein the first set of nodes is a set of syntactic nodes in the parse tree.

17. The method of claim 15, wherein the current abstraction level is deterministic when at least one node in the second set of nodes has at least two possible parent nodes in the third set of nodes.

18. The method of claim 15, wherein the construction of the current abstraction level includes:
accessing the second set of nodes and the third set of nodes;
determining a fourth set of nodes within the third set of nodes that are parents of at least one node in the second set of nodes; and
setting the current abstraction level to include the fourth set of nodes.

19. The method of claim 15, further including:
in response to determining the current abstraction level is not deterministic, creating a fourth set of nodes by:
identifying nodes within the second set of nodes with one possible parent node in the third set of nodes;
adding identified parent nodes to the fourth set of nodes;
identifying nodes within the second set of nodes with at least two possible parent nodes in the third set of nodes; and
determining one of the at least two possible parent nodes to add to the fourth set of nodes; and
setting the fourth set of nodes as the current abstraction level in the PSG.

20-21. (canceled)

22. A computer system to construct and compare program-derived semantic graphs comprising:
memory; and
one or more processors to execute instructions to cause the one or more processors to:
identify a first set of nodes within a parse tree;
set a first abstraction level of a program-derived semantic graph (PSG) to contain the first set of nodes;
access a second set of nodes, the second set of nodes to include nodes in the PSG;
create a third set of nodes, the third set of nodes to include possible nodes at a current abstraction level;
determine whether a current abstraction level is deterministic;
in response to determining the current abstraction level is deterministic, construct the current abstraction level;
access a first PSG and a second PSG; and
determine whether the first PSG and the second PSG satisfy a similarity threshold.

23. The computer system of claim 22, wherein the first set of nodes is a set of syntactic nodes in the parse tree.

24. The computer system of claim 22, wherein the current abstraction level is deterministic when at least one node in the second set of nodes has at least two possible parent nodes in the third set of nodes.

25. The computer system of claim 22, wherein the construction of the current abstraction level includes:
accessing the second set of nodes and the third set of nodes and determine a fourth set of nodes within the third set of nodes that are parents of at least one node in the second set of nodes; and
setting the current abstraction level to include the fourth set of nodes.

26. The computer system of claim 22, further including:
a learning-based abstraction level creator to:
in response to determining the current abstraction level is not deterministic, create a fourth set of nodes, wherein the learning-based abstraction level creator is to:
identify nodes within the second set of nodes with one possible parent node in the third set of nodes;
add identified parent nodes to the fourth set of nodes;
identify nodes within the second set of nodes with at least two possible parent nodes in the third set of nodes; and
determine one of the at least two possible parent nodes to add to the fourth set of nodes; and
set the fourth set of nodes as the current abstraction level in the PSG.

27. (canceled)

28. The computer system of claim 22, including:
accessing a code snippet; and
constructing a parse tree based on the code snippet.

29-35. (canceled)
